(19) United States
(12) Patent Application Publication
(10) Pub. No.: US 2009/0306261 A1
(43) Pub. Date: Dec. 10, 2009

(54) Compatibilizing Polymer Blends by Using Organoclay

(75) Inventors: Miriam Rafailovich, Plainview, NY (US); Mayu Si, Hudson, OH (US)

Correspondence Address: Ronald J. Baron;Hoffmann & Baron, 6900 Jericho Turnpike, Syosset, NY, 11791, US

(73) Assignee: RESEARCH FOUNDATION OF STATE UNIVERSITY OF NEW YORK, Albany, NY (US)

(21) Appl. No.: 11/658,074

(22) PCT Filed: Jul. 21, 2005
(86) PCT No.: PCT/US2005/025850

§ 371 Date: Jun. 12, 2009

Related U.S. Application Data
(60) Provisional application No. 60/589,849, filed on Jul. 21, 2004.

(51) Int. Cl. C08K 5/5415; C08F 8/00

(52) U.S. Cl. 524/262; 524/261; 525/194

(57) ABSTRACT

A method for producing a polymer blend that includes: combining a first polymer, a second polymer and an organoclay to form a mixture, wherein the first polymer is not compatible with the second polymer, and heating the polymer and organoclay mixture to form a compatilized polymer blend. The preferred organoclay is montmorillonite clay functionalized by an intercalation agent. The intercalation agent is a reaction product of a polyamine and an alkyl halide in a polar solvent.

This application claims priority based on U.S. provisional patent application 60/589,849, filed on Jul. 21, 2004, which claims priority based on U.S. application Ser. No. 10/490,882, filed on Mar. 26, 2004, which claims priority based on U.S. PCT/US02/30971, filed on Sep. 27, 2002, which claims the benefit of provisional patent application 60/325,942, filed on Sep. 28, 2001. All of these applications are incorporated herein in their entirety by reference.

This invention was made with Government support under Grant No. DMR0080604 awarded by the National Science Foundation. The Government has certain rights in the invention.

### BACKGROUND OF INVENTION

The present invention relates to homogeneous high performance polymer blends and methods for forming such blends. In particular, the present invention relates to polymer blends that include an organoclay compatibilizer.

Organoclay has been successfully used as a universal compatibilizer to compatibilize polymer blends made by melt mixing. U.S. Pat. No. 6,339,121 B1 discloses a polymer blend composition including a first polymer and a second polymer, which are immiscible, and a compatibilizer. The compatibilizer includes an organoclay that is functionalized by an intercalation agent so that it has an affinity for each of the polymers. The intercalation agent is a reaction product of a polyamine and an alkyl halide in a polar solvent. The preferred alkyl halides are alkyl chloride and alkyl bromide and the preferred polar solvents are water, toluene, tetrahydrofuran, and dimethylformamide. U.S. Pat. No. 6,339,121 B1 is incorporated herein by reference in its entirety.

The Transmission Electron Microscopy (“TEM”) and Scanning Transmission X-Ray Microscopy (“STXN”) results show that the addition of organoclays into polymer blends drastically reduces the average domain size of the component phases. The organoclay goes to the interfacial region between the different polymers and effectively slows down the increase of the domain size during high temperature annealing. The greater compatibility results in the improvement of mechanical and thermal properties. This invention has numerous uses in different areas of the polymer industry, such as the plastic recycling industry and the manufacture of fire retardant polymer products.

Polymer blends produce materials with good balanced properties without having to synthesize novel structural materials. However, most polymer blends tend to phase separate and do not provide advanced properties. Traditional compatibilizers, such as block and graft copolymers, are very system specific and expensive. Consequently, they are not widely used in the industry. Therefore, there is a need for compatibilized polymer blends which have good performance properties and do not phase separate.

### SUMMARY OF THE INVENTION

In accordance with the present invention, a method for producing polymer blends compatibilized with an organoclay is provided. The invention also includes the polymer blends having improved properties that are produced using these methods.

The method for producing a polymer blend includes: combining a first polymer, a second polymer and an organoclay to form a mixture, wherein the first polymer is not compatible with the second polymer; and beating the mixture to form a compatibilized polymer blend. In a preferred embodiment, the first polymer is polystyrene and the second polymer is poly(methyl methacrylate) or polyvinyl chloride. In another preferred embodiment, the first polymer is polycarbonate and the second polymer is styrene-acrylonitrile.

The method for producing a polymer blend can also include combining a third polymer with the first and second polymers and the organoclay. Preferably, the polymer and organoclay mixture is heated at a temperature of about 150-250° C. The preferred organoclay is montmorillonite clay and it is preferably functionalized by an intercalation agent. The intercalation agent can be a reaction product of a polyamine and an alkyl halide in a polar solvent. The preferred alkyl halide is alkyl chloride or alkyl bromide and the preferred polar solvent is water, toluene, tetrahydrofuran or dimethylformamide.

In a preferred embodiment, the compatibilized polymer blends are made by melt mixing at least two polymer components that are not compatible with an organoclay and then heating the mixture. The steps for the method include: (1) combining a first polymer, a second polymer and an organoclay to form a mixture, wherein the first polymer is not compatible with the second polymer; and (2) melt mixing the mixture to form a compatibilized polymer blend. The method is simple and very effective in producing homogenous polymer blends with balanced properties. In other embodiments, the compatibilized polymer blend can include additional polymers which are not compatible with the first and/or second polymer.

### BRIEF DESCRIPTION OF THE FIGURES

Other objects and many attendant features of this invention will be readily appreciated as the invention becomes better understood by reference to the following detailed description when considered in connection with the accompanying drawings wherein:

FIGS. 1.1(a)-(c), 1.2(a)-(c) and 1.3(a)-(c) show the dynamic morphology change of PS/PMMA with and without clay during annealing at 190° C. for different periods of time.

FIG. 2(a) shows the near edge x-ray absorption fine structure spectra of PS and PMMA and FIGS. 2(b)-(d) show Scanning Transmission X-Ray Microscopy (STXM) images of PS/PMMA blends with and without clay.

FIGS. 3(a) and (b) show STXM images of polycarbonate/styrene-acrylonitrile (“PC/SAN”) blends with and without clay.

FIGS. 4(a) and (b) are graphs showing tie glass transition change of polycarbonate/styrene-acrylonitrile (“PC/SAN”) blends with and without clay.

FIGS. 5(a) and 5(b) show the Scanning Transmission X-Ray Microscopy (STXM) images of polystyrene/polyvinyl chloride (“PS/PVC”) with and without clay.

FIG. 6 shows the DMA spectra of PS/PVC with and without clay.

FIGS. 7(a)-(f) show the Scanning Transmission X-Ray Microscopy (STXM) images of PS/PMMA/PVC (33/33/33) with and without clay.

### DETAILED DESCRIPTION OF THE INVENTION

The present invention relates to homogenous high performance polymer blends that are produced by melt mixing at least tho polymer components with an organoclay. The method is simple and cost-efficient and has a variety of uses in the polymer industry. Organoclay as a compatibilizer is not system-specific and can be used in different polymer blends, such as polystyrene/poly(methyl methacrylate) (“PS/PMMA”), polycarbonate/styrene-acrylonitrile (“PC/SAN”) and polystyrene/polyvinyl chloride (“PS/PVC”). Preferred embodiments of the present invention include organoclay and uncompatibilized polymer blends, most preferably binary and tertiary systems. Organoclay acts as a compatibilizer and effectively improves the performance of polymer blends. Organoclay also improves the fire-retardancy properties of polymers and polymer blends which allows them to be used in a wider variety of applications.

The terms “compatible polymers” and “incompatible polymers” refer to the degree of intimacy of polymer blends. Compatible polymers are substantially miscible, i.e., they are capable of being mixed in any ratio without separation of two phases. Compatibilization involves both physical and chemical properties. A fully compatibilized blend involves the mixing at the molecular level of two polymers. From a practical standpoint, it is useful to refer to a polymer blend as compatible when it does not exhibit gross characteristics of polymer segregation. Under microscopic inspection, a miscible blend consists of a single phase. On a molecular level, the molecules of the polymers intermingle.

Compatibilization is manifested by a single glass-transition temperature for the polymer blend, instead of two separate glass-transition temperatures. The glass-transition temperature, T_{g}, of a polymer is the temperature at which the molecular chains have sufficient energy to overcome attractive forces and move vibrationally and translationally. The glass-transition temperature of a compatible polymer blend will occur at the approximate geometric mean of the two separate glass-transition temperatures for the blended polymers. This relationship is set forth in Eq. (1) as follows:

(A_{Tg})×(A_{VF})+(B_{Tg})×(B_{VF})=(A+B)_{Tg} (Eq. 1)

Where A_{Tg} is the glass transition temperature of polymer A, B_{Tg} is the glass transition temperature of polymer B, (A+B)_{Tg} is the glass transition temperature of polymers A and B after they have been blended together and A_{VF} and B_{VF} are the volume fractions of polymers A and B, respectively. This is known as the “Flory-Fox relationship.” The relationship also applies to the specific heats of blends of compatible polymers.

Accordingly, the term compatible polymers, as used herein, refers to polymers which, when blended, do not exhibit gross characteristics of polymer segregation and substantially form a single phase mixture.

Organoclay can be used as a universal compatibilizer to improve the miscibility of polymer blends. Organoclay is inexpensive and the methods used to produce polymer blends with organoclay are relatively simple. An even more important attribute of organoclay when used as a compatibilizer is that it is not system specific and can be used with a variety of polymer blends. Polymer blends that include organoclay have superior properties and provide numerous uses in the plastics industry and in the manufacture of fire retardant products.

The compatibilizer includes an organoclay, which has been functionalized by an intercalation agent, whereby it has an affinity for each of the polymers. The intercalation agent is a reaction product of a polyamine and an alkyl halide in a polar solvent. The preferred alkyl halides are alkyl chloride and alkyl bromide and the preferred polar solvents are water, toluene, tetrahydrofuran, and dimethylformamide.

The polymer blends of the present invention include about 10 to 90% by weight of a first polymer component, about 10 to 90% by weight of a second polymer component and about 2 to 25% by weight of an organoclay. Preferred embodiments of the polymer blends include about 20 to 80% by weight of a first polymer component, about 20 to 80% by weight of a second polymer component and about 5 to 15% by weight of an organoclay. Other preferred embodiments of the polymer blends include about 30 to 70% by weight of a first polymer component, about 30 to 70% by weight of a second polymer component and about 7 to 12% by weight of an organoclay. The polymer blends can include more than two polymer components made up of about 75-98% by weight of polymer components and about 2 to 25% by weight of an organoclay. Preferably the polymer blends include about 85-95% by weight of polymer components and about 5 to 15% by weight of an organoclay and most preferably about 88-93% by weight of polymer components and about 7 to 12% by weight of an organoclay.

The polymer components and the organoclay are mixed together and heated to form the polymer blends. In one embodiment, at least two polymer components are melt mixed with an organoclay at a temperature in the range of about 150-250° C., preferably about 170-200° C.

### Examples

The examples set forth below serve to provide further appreciation of the invention but are not meant in any way to restrict the scope of the invention.

### Example 1

Polymer blends of the present invention were formed by mixing polymer components with organoclay in a twin screw Brabender extractor at a temperature of 170-200° C. with a shear rate of 20 RPM for 1 minute, then at 100 RPM for 10 minutes. The organoclay is a functionalized clay, preferably functionalized montmorillonite clay, and most preferably Montmorillonite Cloisite 6A. For the tests referred to in the present application, Clay lot#20000626XA-001 from Southern Clay Products Inc. was used to form the polymer blends.

TABLE 1
Compositions of Polymer Blends

| System | Control (weight ratio) | Compatibilized (weight ratio) |
|---|---|---|
| 1 | PS/PMMA | PS/PMMA/Cloisite 6A |
| | (50/50) | (45/45/40) |
| 2 | PS/PMMA | PS/PMMA/Cloisite 6A |
| | (30/70) | (27/63/10) |
| 3 | PC/SAN | PC/SAN/Cloisite 6A |
| | (50/50) | (45/45/10) |
| 4 | PS/PVC | PS/PVC/Cloisite 6A |
| | (50/50) | (45/45/10) |
| 5 | PS/PMMA/PVC | PS/PMMA/PVC |
| | (33/33/33) | (30/30/30/10) |

In Table 1, PS is polystyrene, PMMA is poly(methyl methacrylate), PC is polycarbonate, SAN is styrene-acrylonitrile and PVC is polyvinyl chloride. After the polymer blends were formed, they were subjected to various testing procedures that included Transmission Electron Microscopy (“TEM”), Scanning Transmission X-Ray Microscopy (“STXM”), Dynamical Mechanical Analyzer (“DMA”) and Dynamic Scanning Calorimetry (“DSC”).

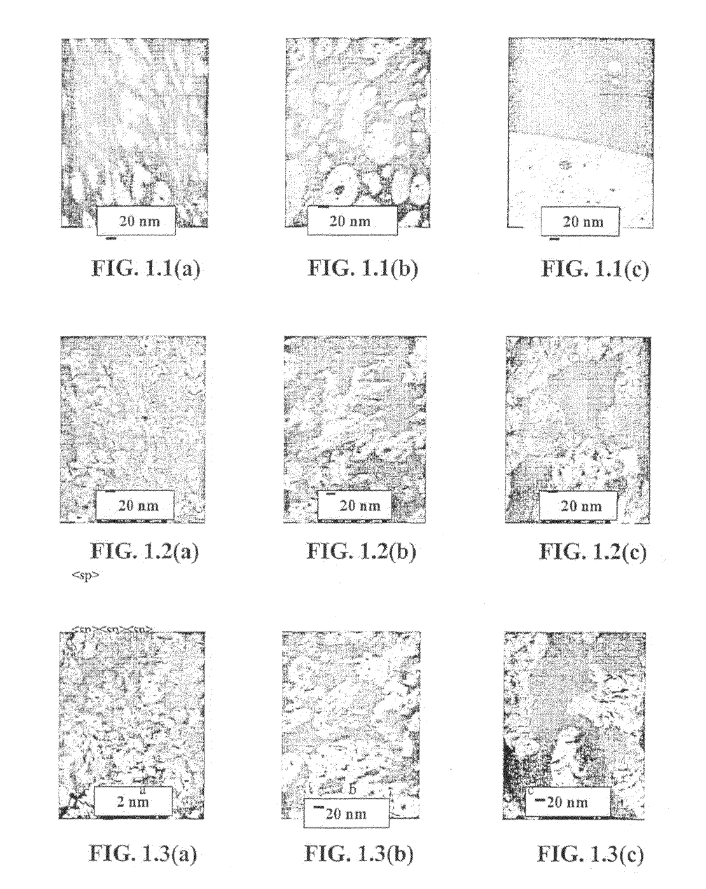

FIG. 1 shows three rows of Transmission Electron Microscopy (“TEM”) images of PS/PMMA blends with and without clay and at different temperatures which are divided into three columns. Row 1 includes three images of a 50/50 blend of PS/PMMA without any clay; Row 2 includes three images of a 45/45/10 blend of PS/PMMA/Cloisite 6A mixed together; and Row 3 includes three images of a 45/45/10 blend of PS/PMMA/Cloisite 6A mixed separately. In the first column of images, the three different blends are quenched in liquid N₂. The second column of images shows the blends after they have been annealed at 190° C. for a half hour and the third column shows the blends after they have been annealed at 190° C. for 14 hours.

Three extruded samples of each of the three blends were prepared and quenched in liquid nitrogen to freeze the morphology. A cross-section of the first samples of each blend were sliced on a Reichert Microtome with a diamond knife and the images are shown in the first column of FIG. 1. The remaining two samples of the three blends were then annealed in an oven at 190° C. in a high vacuum for different times to observe the morphology change. The second samples of each of the three blends were heated for one-half hour and the third samples of each of the three blends were heated for 14 hours. Cross-sections of the second and third samples of each of the three blends were taken and the images are shown in the second and third columns of FIG. 1.

The TEM images in FIGS. 1.1(a)-(c), 1.2(a)-(c) and 1.3(a)-(c) show the dynamic morphology change of PS/PMMA with and without clay during annealing at 190° C. for different periods of time. The images in FIG. 1.1a-c show a PS/PMMA (50/50) blend without clay. The images in FIG. 1.2(a)-(c) show a PS/PMMA/Cloisite 6A (45/45/10) blend where the components were mixed together. The images in FIG. 1.3(a)-(c) show a PS/PMMA/Cloisite 6A (45/45/10) blend where the polymers and clay were mixed separately.

The images in FIGS. 1.1(a), 1.2(a) and 1.3(a) show blends that were quenched in liquid N₂ The images in FIGS. 1.1(b), 1.2(b) and 1.3(b) were annealed at 190° C. for 0.5 hour. The images in FIGS. 1.1(c), 1.2(c) and 1.3(c) were annealed at 190° C. for 14 hours.

FIGS. 1.1(a)-(c), 1.2(a)-(c) and 1.3(a)-(c) show that the phase structures of the three blends are similar after annealing for half an hour. However, after annealing for 14 hours in PS/PMMA without clay, the two phases of PS and PMMA are totally separated. In the PS/PMMA Cloisite blends, the clay effectively slows down the increase in the domain size and the average domain size is around 400-600 nm. The clay goes to the interfacial area between the PS and the PMMA phase and is preferred by the PMMA phase.

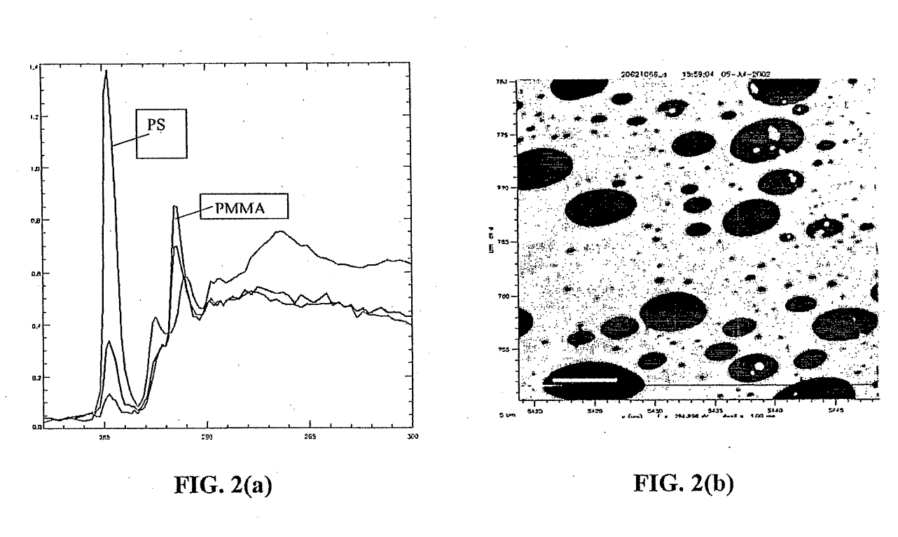

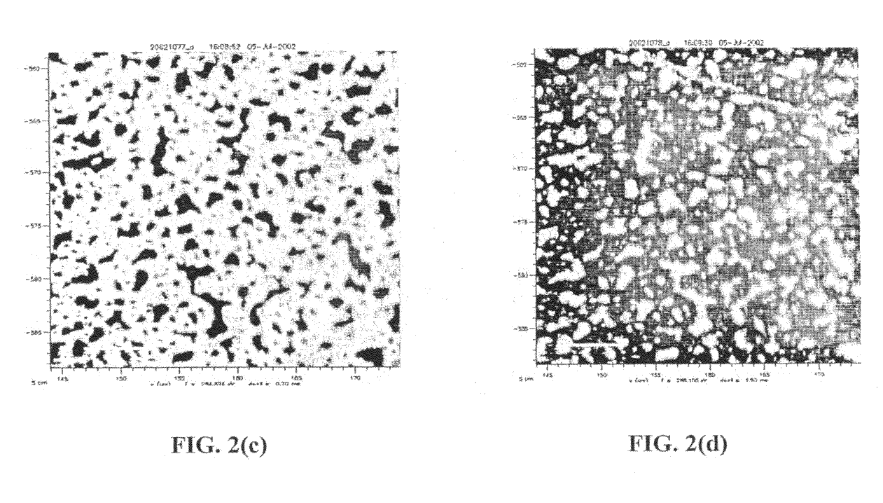

FIG. 2(a) shows the near edge x-ray absorption fine structure spectra of PS and PMMA and FIGS. 2(b)-(d) show Scanning Transmission X-Ray Microscopy (STXM) images of PS/PMMA blends with and without clay annealing at 190° C. for 14 hours. FIG. 2(b) is an image of a 30/70 PS/PMMA blend without clay and FIGS. 2(c) and (d) are images of a 23/67/10 PS/PMMA/Cloisite 6A blends taken at different energy levels. Since STXM requires the sample to be transmitted by x-ray, thin cross sections of the samples were prepared using the Reichert Microtome.

The near edge x-ray absorption fine structure spectra of PS and PMMA are shown in FIG. 2(a). The PS has high absorption at the photo energy of 285.2 eV, while at 288.5 eV PMMA has most of the absorption.

In the micrographs shown in FIGS. 2(b) to (d), dark areas represent higher absorption and light areas represent lower absorption. In FIG. 2(b), the morphology of the 30/70 immiscible blend in the absence of clay shows that the minority of PS phase forms isolated, spherical islands in the PMMA matrix. The interface between PS and PMMA is very sharp and clear. However, when 10 wt % Cloisite 6A is introduced in this system, the morphology is dramatically different, which is shown in FIGS. 2(c) and (d). The big spherical PS domains that formed in the absence of Cloisite 6A (see FIG. 2(b)) are broken down into small domains with different shapes as shown in FIGS. 2(c) and (d). The PS domain size is greatly decreased and domain boundaries become jagged.

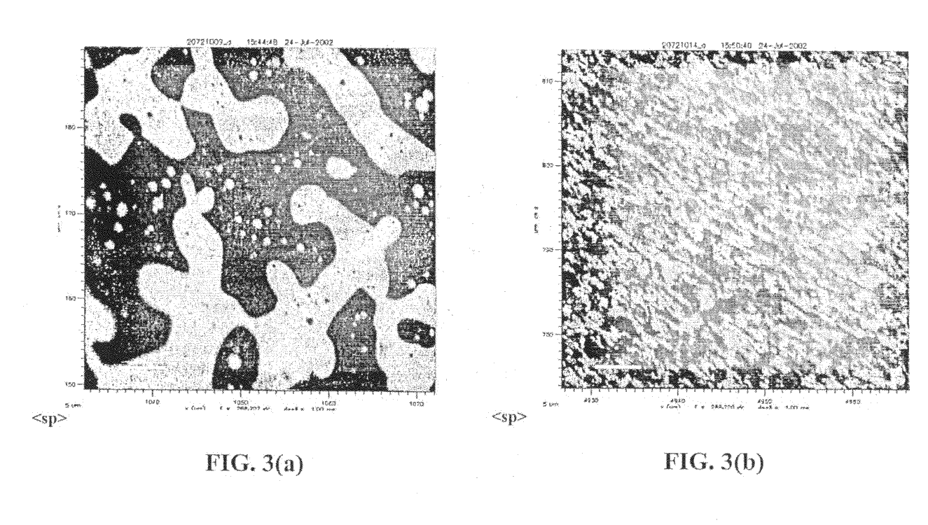

FIGS. 3(a) and (b) show STXM images of polycarbonate/styrene-acrylonitrile (“PC/SAN”) blends with and without clay. FIG. 3(a) is an image of a 50/50 PC/SAN blend without clay and FIG. 3(b) is a 45/45/10 PC/SAN/Cloisite 6A blend.

FIGS. 3(a) and (b) show 40×40 μm STXM images of PC/SAN under the photo energy (E_{x-ray}) of 286.7 eV, which represents the high absorption of SAN. In FIG. 3(a), it can be seen that, in the PC/SAN blend without clay, the domain size is large and the interface is sharp. However, FIG. 3(b) shows that the addition of 10 wt % Cloisite 6A dramatically decreases the domain size and obscures the interface between PC and SAN.

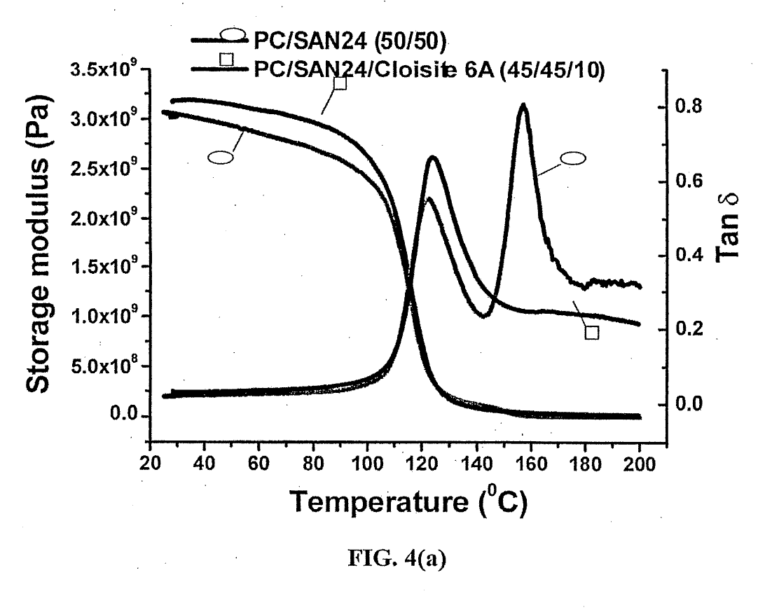

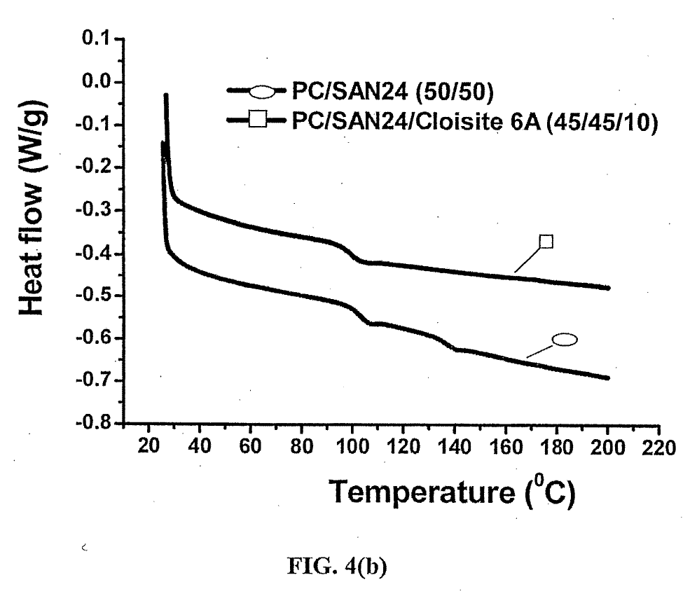

FIGS. 4(a) and (b) are graphs showing the glass transition change of polycarbonate/styrene-acrylonitrile (“PC/SAN”) blends with and without clay. The graph in FIG. 4(a) compares the glass transition temperature of a 50/50 PC/SAN blend without clay and a 45/45/10 PC/SAN/Cloisite 6A blend using a Dynamical Mechanical Analyzer (“DMA”) and FIG. 4(b) compares the same blends using Dynamic Scanning Calorimetry (“DSC”).

The DMA spectra of PC/SAN with and without clay are shown in FIG. 4(a), where two distinct glass transition temperatures (T_{g}), 121° C. and 158° C., are found in a PC/SAN blend that does not include clay. These two glass transition temperatures correspond directly to the glass transition temperatures of SAN (121° C.) and PC (158° C.). FIG. 4(a) shows that after the introduction of 10 wt % Cloisite 6A, the T_{g} of PC dramatically shifts almost 18° C. in the direction of the SAN T_{g}. This shift in the T_{g} of PC indicates the compatibilization of the two polymers due to the addition of the clay also occurs on the molecular level.

The DMA results are confirmed by the data obtained by DSC and shoe in FIG. 4(b), which shows a similar trend. Dynamic Scanning Calorimetry allows the determination of temperature dependent reaction parameters such as reaction onset, reaction duration, etc. Additionally, phase transitions especially with polymeric materials can be measured, where the glass temperature T_{g} is one of the key parameters.

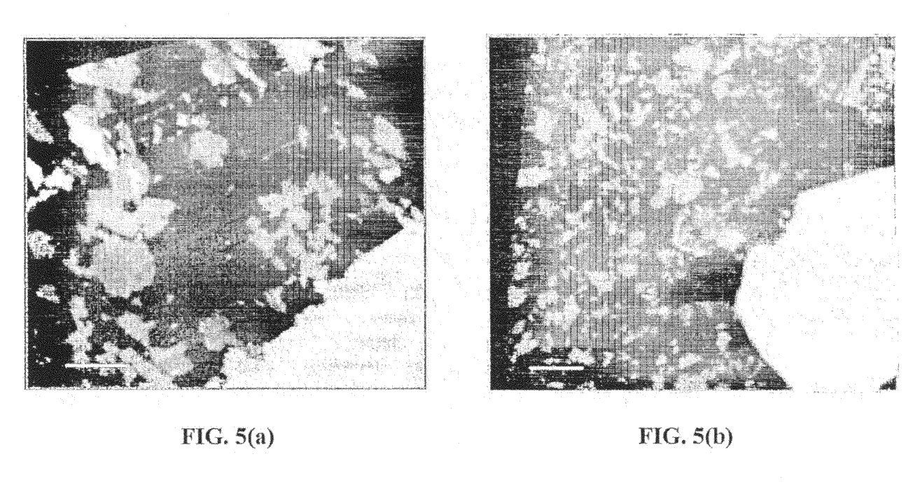

FIGS. 5(a) and 5(b) show the Scanning Transmission X-Ray Microscopy (STXM) images of polystyrene/polyvinyl chloride (“PS/PVC”) with and without clay, i.e., PS/PVC/Cloisite 6A (45/45/10) and PS/PVC (50/50). FIGS. 5(a) and (b) show 80×80 μm STXM images of PS/PVC and PS/PVC/Cloisite 6A under the photo energy (E_{x-ray}) of 285.2 eV (which represents the high absorption of PS), where it can be seen that the PS/PVC without clay the domain size is big and the interface is sharp. The addition of 10 wt % Cloisite 6A dramatically decrease the domain size and make the interface obscure.

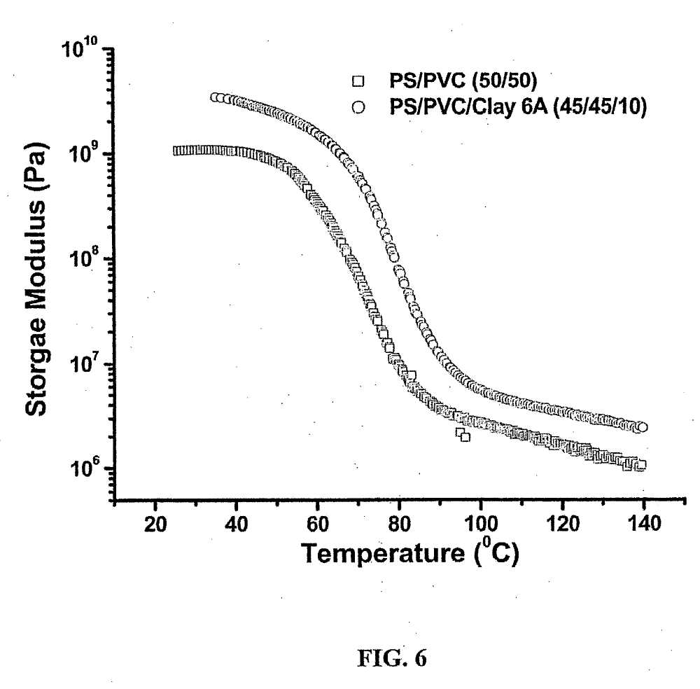

FIG. 6 shows the DMA spectra of PS/PVC with and without clay, i.e., PS/PVC/Cloisite 6A (45/45/10) and PS/PVC (50/50). The compatibilization effect also reflects on the mechanical properties improvement, which is characterized by the DMA. The result in FIG. 6 shows that the introduction of 10 wt % Cloisite 6A increases the storage modulus of PS/PVC 2.5 times, which is relative to the morphology change in FIG. 5.

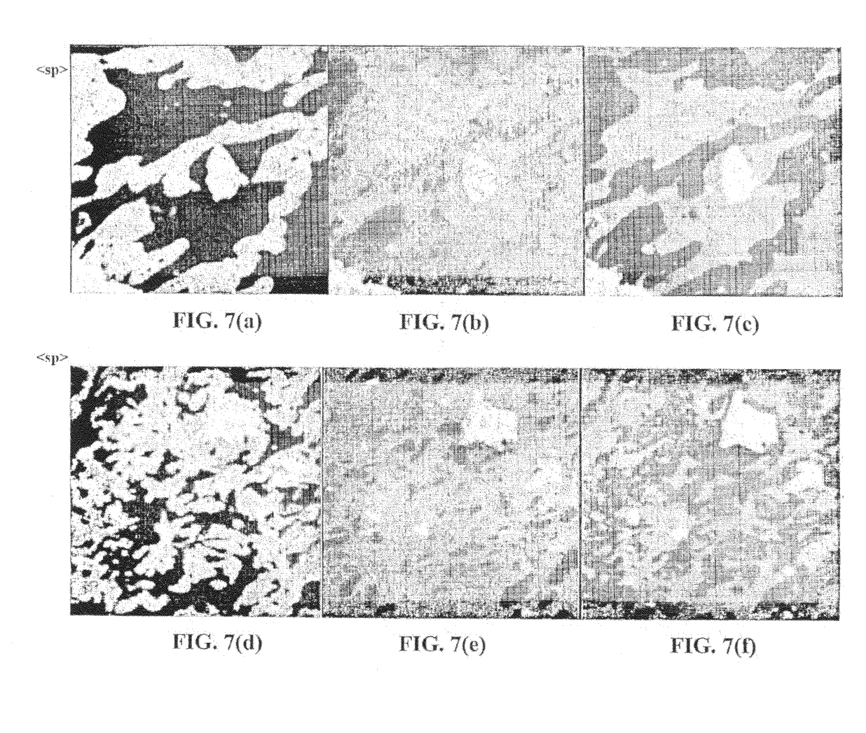

FIGS. 7(a)-(f) show the Scanning Transmission X-Ray Microscopy (STXM) images of PS/PMMA/PVC (33/33/33) with and without clay. FIG. 7 shows that, in the absence of clay, the system has large domains and a sharp interface. After the addition of clay, the domain size is greatly decreased and the interface becomes jagged due to the clay located at the interface.

FIGS. 7(a), (b) and (c) show 20×20 μm STXM images of PS/PMMA/PVC (33/33/33) under different photo energy, FIG. 7(a) shows E_{x-ray}=285.2 eV, which represents high absorption of PS, FIG. 7(b) shows E_{x-ray}=287.8 eV, which represents high absorption of PVC, FIG. 7(c) shows E_{x-ray}=288.5 eV, which represents high absorption of PMMA. FIGS. 7(d), (e) and (f) show 20×20 μm STXM images of PS/PMMA/PVC/Cloisite 6A (30/30/30/10) under different photo energies, 285.2 eV, 287.8 eV and 288.5 eV, for FIGS. 7(d), (e) and (f) respectively.

Thus, while there have been described the preferred embodiments of the present invention, those skill ed in the art will realize that other embodiments can be made without departing from the spirit of the invention, and it is intended to include all such further modifications and changes as come within the the scope of the claims set forth herein.

1. A method for producing a polymer blend comprising:
combining a first polymer, a second polymer and an organoclay to form a mixture, wherein the first polymer is not compatible with the second polymer; and
heating and mixing the mixture to form a compatibilized polymer blend,
wherein the mixture is heated at a temperature of about 150 to about 250° C. and mixed at a shear rate of between about 20 and about 100 RPM.

2. The method for producing a polymer blend according to claim 1, wherein the first polymer is polystyrene and the second polymer is poly(methyl methacrylate) or polyvinyl chloride.

3. The method for producing a polymer blend according to claim 1, wherein the first polymer is polycarbonate and the second polymer is styrene-acrylonitrile.

4. The method for producing a polymer blend according to claim 1 further comprising combining a third polymer with the first and second polymers and the organoclay.

5. The method for producing a polymer blend according to claim 1, wherein the mixture is heated at a temperature of about 170 to about 200° C.

6. The method for producing a polymer blend according to claim 1, wherein the organoclay is montmorillonite clay.

7. The method for producing a polymer blend according to claim 1, wherein the organoclay is functionalized by an intercalation agent.

8. The method for producing a polymer blend according to claim 7, wherein the intercalation agent is a reaction product of a polyamine and an alkyl halide in a polar solvent.

9. The method for producing a polymer blend according to claim 8, wherein the alkyl halide is alkyl chloride or alkyl bromide and the polar solvent is water, toluene, tetrahydrofuran or dimethylformamide.

10. The method for producing a polymer blend according to claim 7 further comprising a third polymer.

11. A polymer blend made in accordance with claim 1.

12. A polymer blend made in accordance with claim 10.

13. A method for producing a polymer blend comprising:
combining a first polymer, a second polymer, a third polymer and an organoclay to form a mixture, wherein the first polymer is not compatible with the second polymer or the third polymer and the second polymer is not compatible with the third polymer; and
heating and mixing the mixture to form a compatibilized polymer blend;
wherein the mixture is heated at a temperature of about 170 to about 200° C. and mixed at a shear rate of between about 20 and about 100 RPM.

14. The method for producing a polymer blend according to claim 13, wherein the first polymer is polystyrene, the second polymer is poly(methyl methacrylate) and the third polymeris polyvinyl chloride.

15. The method for producing a polymer blend according to claim 13, wherein the first polymer is polycarbonate and the second polymer is styrene-acrylonitrile.

16. The method for producing a polymer blend according to claim 13 further comprising combining a third polymer with the first and second polymers and the organoclay.

17. The method for producing a polymer blend according to claim 13, wherein the organoclay is montmorillonite clay.

18. The method for producing a polymer blend according to claim 13, wherein the organoclay is functionalized by an intercalation agent, wherein the intercalation agent is a reaction product of a polyamine and an alkyl halide in a polar solvent.

19. The method for producing a polymer blend according to claim 18, wherein the alkyl halide is alkyl chloride or alkyl bromide and the polar solvent is water, toluene, tetrahydrofuran or dimethylformamide.

20. A polymer blend made in accordance with claim 13.
